(19) United States
(12) Patent Application Publication
(10) Pub. No.: US 2009/0319351 A1
(43) Pub. Date: Dec. 24, 2009

(54) Measuring the effectiveness of a person testimonial promotion

(75) Inventors: Harry R. Soza, San Jose, CA (US); Mark Wayman, Oakland, CA (US); Stephen J. Brown, Woodside, CA (US)

Correspondence Address: LUMEN PATENT FIRM, 350 Cambridge, Suite 100, PALO ALTO, CA, 94306, US

(73) Assignee: vyrl mkt, Inc.

(21) Appl. No.: 12/460,223

(22) Filed: Jul. 14, 2009

Related U.S. Application Data
(63) Continuation-in-part of application No. 12/288,614, filed on Oct. 21, 2008.
(60) Provisional application No. 61/132,481, filed on Jun. 18, 2008.
(60) Provisional application No. 61/134,904, filed on Jul. 14, 2008.

(51) Int. Cl. G06Q 30/00

(52) U.S. Cl. 705/14.13; 705/14.44; 705/14.66

(57) ABSTRACT

Behavioral targeting to push promotional offers to a person, such as an artist, celebrity, athlete, politician, of a fan-based network is provided. The selection and redemption of promotional offers can increase by providing persons of a fan-based network with relevant and high value offers. In addition, marketing campaigns can increase their effectiveness with knowledge and identification of persons having a high degree of influence on other persons. A person's measure of influence is determined by characterizations of the person's fans based on monitored actions of the fans. Relevant promotional offers can be targeted to a consumer based indirectly on the actions of the fans of the consumer in addition to the direct behavior of the consumer himself. The actions and behavior of a consumer and his or her fans can be tracked within the fan-based network setting. Pushing relevant and high value offers enables rapid and viral spread of offers.

### CROSS-REFERENCE TO RELATED APPLICATIONS

This application is a continuation-in-part (CIP) of U.S. Non-Provisional application Ser. No. 12/288,614 filed Oct. 21, 2008, which is incorporated herein by reference. U.S. Non-Provisional application Ser. No. 12/288,614 filed Oct. 21, 2008 claims priority from U.S. Provisional Patent Application 61/132,481 filed Jun. 18, 2008. This application also claims priority from U.S. Provisional Application 61/134,904 filed Jul. 14, 2008, which is incorporated herein by reference.

### FIELD OF THE INVENTION

The invention relates generally to online promotions. More particularly, the invention relates to a person's testimonial of promotional offers in an online environment.

### BACKGROUND

Promotional offers provide a mechanism for product sponsors to advertise their products and receive limited information of the consumers of their products, such as the zip codes in which the offers were redeemed. Traditionally, promotional offers take on the form of coupon advertisements in newspapers and magazines. The traditional marketing campaigns are often unsuccessful as consumers typically ignore the advertisements or find clipping coupons to be burdensome. More recently, promotional offers have widely expanded to the online environment to include advertising emails and webpage banner advertisements. However, the existing online offers have encountered similar difficulties as the traditional marketing campaigns as consumers commonly find them to be a nuisance.

Many existing marketing campaigns include famous spokespersons, such as e.g. artists, to promote products. The sponsors rely on the popularity or celebrity of the spokespersons to attract consumers. Artists typically agree to act as spokespersons to increase their own viewership, to have another source of revenue, and/or because they believe in the product. However, sponsors typically are unable to measure the ability of the artist to attract consumers. In particular, since traditional marketing campaigns commonly use passive advertisements, such as television commercials or print advertisement, there is no easy way to measure if the artist's appearance on the passive advertisements has an influence on consumer behavior.

Because of the difficulty in measuring the effectiveness of an artist spokesperson, there are financial risks for and reluctance of sponsors to hire artists. This reluctance to hire artists often prevents an artist to gain additional revenue, particularly for new or struggling artists. Furthermore, the sponsors and artists generally have limited mechanisms to know the particular demographic information of their consumers and fans.

The present invention addresses at least the difficult problems of distributing promotional offers and advances the art with a method and system for pushing promotional offers in a fan-based network.

### SUMMARY OF THE INVENTION

The present invention is directed to a method and a system for pushing promotional offers based on behavioral targeting in a fan-based (social) network. In a particular embodiment, the present invention is directed to a method of pushing promotional offers to a person of a computer-implemented fan-based network based on behavior of fans of the person. The fans are a fan of the person and associated and linked with the person through a computer-implemented network. The person could be an artist, an athlete, a celebrity, a political figure, or any other person with a fan-base, whereby the person and fans are linked through a computer-implemented network.

The method includes monitoring one or more actions of multiple fans of the person of the fan-based network. The monitored actions are used to characterize the fans of the person with respect to one or more domains. A measure of influence of the person with respect to one or more domains is determined at least partially based on the characterizations of the fans of the person. One or more promotional offers are pushed to the person based on the measure of influence of the person. The promotional offers are also associated with one or more domains and the pushed promotional offer is selected based, at least in part, on the domain of the pushed promotional offer.

The monitored actions of the fans of the person include an acceptance of promotional offers, a referral of promotional offers, a redemption of promotional offers, a frequency of receiving promotional offers, a frequency of referring promotional offers, a stated interest of promotional offers, a stated interest, or any combination thereof. The promotional offers are directed to a product or a service of one or more sponsors, and can include a discount, a coupon, an advertisement, a voucher, an incentive to purchase, a ticket, an access pass, or any combination thereof.

In a preferred embodiment, the value of the promotional offer pushed to the person is determined based at least partially on the measure of influence of the person. In another embodiment, a refer function is provided to allow the person to refer the pushed promotional offer to fans of the person and the value of the pushed promotional offer is determined at least partially on a number of referrals by the person. In yet another embodiment, the promotional offer pushed to the person includes an identifier associated with one of the fans of the person, wherein the identifier includes text, an audio clip, a visual graphic, an audio-visual clip, or any combination thereof, associated with the fan of the person.

In an embodiment, the behavior of a person is tracked, wherein the measure of influence of the same person is at least partially based on the tracked behavior. It is noted that in certain embodiments, the relationship between a person and the fans of the person is bidirectional, wherein the person can refer offers to and receive offers from a fan.

In a preferred embodiment, the method includes providing a survey to the person, wherein the survey is related to an interest of the person, an interest of the fans of the person, a usage pattern of the person, a usage pattern of one or more of the fans of the person, or any combination thereof. The survey can be used to determine a relevant domain for the person. Another promotional offer is selected and pushed to the person, wherein the selection is based on the relevant domain.

The invention is also directed to a system for measuring influence and pushing promotional offers to one or more persons of a fan-based (social) network. The system includes a computer-implemented fan-based network of a plurality of persons, wherein each of the persons of the social network has one or more fans. The system also includes a monitor function and a characterize function for monitoring actions of the fans and characterizing the fans with respect to one or more domains based on the monitored actions, respectively. An influence function is provided for determining a measure of influence of the persons of the fan-based network with respect to one or more domains. The measure of influence is determined at least partially based on the characterization of the fans of the persons. The system also includes an offer function for pushing one or more promotional offers to be received by at least one of the persons, wherein the pushed the promotional offers are based on the measure of influence of the receiving persons and the domains associated with the pushed promotional offers.

To exemplify, in one embodiment the invention is directed to the measurement of the effectiveness of a person's testimonial like an artist through online promotions. The artist can include a musician, a band, a comedian, a writer, a painter, a photographer, an actor, a performing artist, or any individual or group capable of acting as spokesperson(s). Each artist typically has a fan base of multiple fans. The fans of a fan base generally share one or more common attributes or interests. Unlike traditional passive media, online communication, such as Internet communication, allows artists to be in direct communication link with their fans. In an embodiment of the present invention, each artist uses Internet-based technology, such as a downloadable widget or a social network application, to be in contact with the artist's fan base. The widget or application allows the artist to market his or her own products, such as music samples, performance videos, or concert dates.

Sponsors may be interested in associating one or more artists with products and/or services. An artist can be a spokesperson for a sponsor and offer a testimonial to encourage fans to try the sponsor's products and/or services. In a preferred embodiment, promotional offers are communicated to the fans of an artist through Internet communication paths, such as a widget or social network application, which exists between the artist and his or her fan base. The promotional offer can include any combination of video, audio, online, or printed format and can be accompanied by testimonial endorsement by the artist. By using Internet communication paths, the offers can be tracked from distribution all the way through the point-of-sale. By tracking the offers, the effectiveness of the artist-promoted offers can be measured.

An embodiment of the present invention includes demographic information of an artist's fan base. Promotional offers belong to domains relating to the demographic information and are pushed to the fan base, preferably, by using an existing communication connection between the artist and the fan base. The offers can include testimonial promotion for the offer by the artist. The offers are tracked through the redemption and sales process and the tracked data is recorded to measure the effectiveness of the artist-supported promotion. In particular, the effectiveness can be measured with respect to the domains and the demographic information to test the overlap of the artist's fan base demographic information with a product. In addition to measuring the promotion effective of an artist, the consumer behavior of an individual fan, as well as the group fan base, can be measured.

### BRIEF DESCRIPTION OF THE FIGURES

The present invention together with its objectives and advantages will be understood by reading the following description in conjunction with the drawings, in which:

FIG. 1 shows an example of pushing promotional offers to a person of a social network having a plurality of fans according to an embodiment of the invention.

FIG. 2 shows an example of pushing offers belonging to domains A, B to a person with fans characterized as being associated with domains A, B according to an embodiment of the invention.

FIG. 3 shows an example of characterizing fan F₁ of person P based on referrals of offers between fan F₁ and another person P′ according to an embodiment of the invention.

FIG. 4 shows an example of using a person's fans as a filter to determine the person's measure of influence with respect to various domains according to an embodiment of the invention.

FIG. 5 shows a flowchart of an example method of pushing promotional offers according to an embodiment of the invention.

FIG. 6 shows a flowchart of an example method of pushing promotional offers and determining the value of the pushed offers based on a measure of influence according to an embodiment of the invention.

FIG. 7 shows an example offer application display on a fan-based (social) network according to an embodiment of the invention.

FIG. 8 shows examples of offers that include identifiers of fans according to an embodiment of the invention.

FIG. 9 shows an example offer application display for sharing or referring offers to fans in a fan-based (social) network according to an embodiment of the invention.

FIG. 10 shows an example offer application display for inviting fans to join the offer application according to an embodiment of the invention.

FIGS. 11A-B show an example of providing a survey to be completed by a person of a fan-based network and pushing offers based on the completed survey according to an embodiment of the invention.

FIG. 12 shows an example of a survey to be completed by a person to allow the person to receive improved offers according to an embodiment of the invention.

FIG. 13 shows an example offer distribution system according to an embodiment of the invention.

### DETAILED DESCRIPTION OF THE INVENTION

Effectively marketing products and services through promotional offers can be a daunting task. An effective marketing campaign must be able to reach a large number of potential consumers and provide them with relevant offers that they will be interested in receiving and redeeming. Furthermore, for offers that can be referred, a marketing campaign can increase its effectiveness by identifying consumers who have a great deal of influence over other consumers. The present invention is directed to obtaining information to identify influential users and to provide relevant offers to those users.

The present invention is directed at using inherent characteristics of fan-based (social) networks for effective behavioral targeting to push promotional offers to fans of a person. The fans are a fan of the person and associated and linked with the person through a computer-implemented network. The person could be an artist, an athlete, a celebrity, a political figure, or any other person with a fan-base, whereby the person and fans are linked through a computer-implemented network.

A computer-implemented fan-based network could comprise a plurality of persons, who are communicatively connected through a communication network, such as the Internet. Generally, information related to each person is stored by the social network application, some of which is accessible by other persons and applications. The information relating to persons of a social network can include stated interests of the persons, interests that have been confirmed through prior activities of the person, either in the social network or through outside sources (e.g. an actor is also an surfer), demographic and public personal history (e.g. an athlete overcame a serious disease), location-related facts, affiliations with third-party groups not directly related to the person's celebrity, and other life facts and actions that characterize impressions that the fans of the person may share and which may be expected to create influence within a business domain.

Importantly, each person has fans, who are often also members of the fan-based network, themselves. However, a fan's friend does not necessarily have to be a member of the fan-based network. Oftentimes, a person has a pre-existing relationship with one or more of his or her fans.

The present invention is directed to behavioral targeting based on relationships and interactions between a person of a fan-based network and his or her fans for pushing promotional offers. By monitoring actions of persons and their fans, influential persons can be identified and relevant offers can be provided to them.

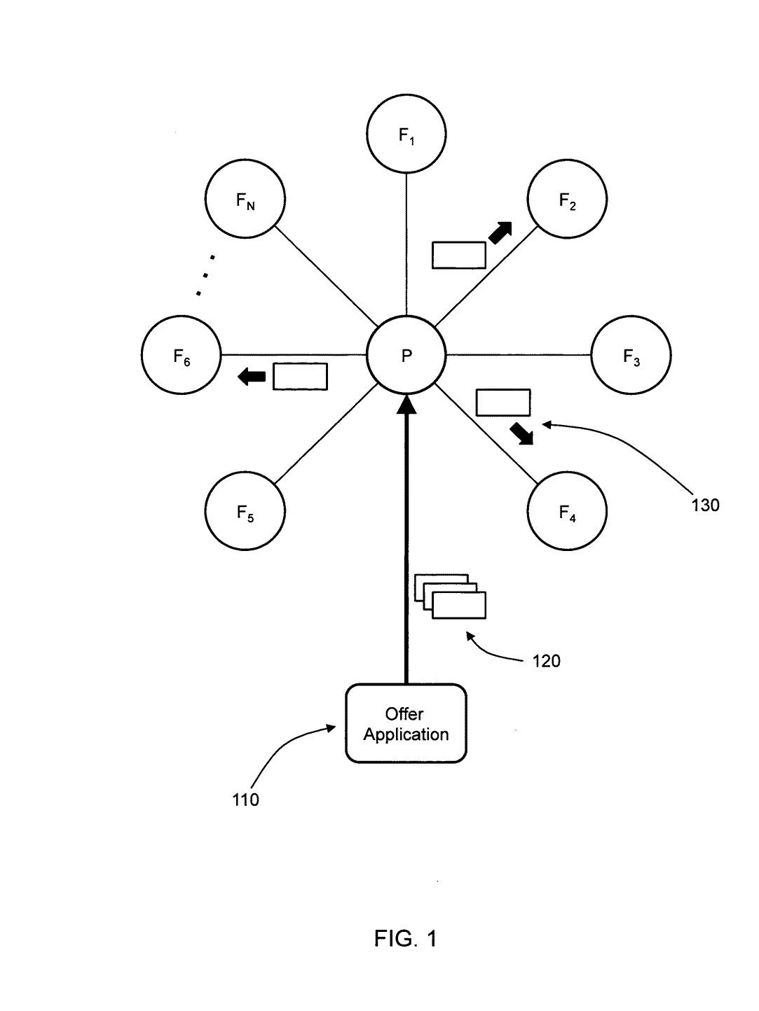

FIG. 1 shows a person P of a computer-implemented fan-based network and the person's fans F₁-F_{N}, whom person P is connected with through the fan-based network. Person P receives promotional offers 120 through an offer application 110. The offer application 110 can be a computer application downloadable and usable on the fan-based network or can be any application for pushing promotional offers 120 that is accessible by person M. A promotional offer 120 includes, but is not limited to, a discount, a coupon, an advertisement, a voucher, an incentive to purchase, a ticket, an access pass, or any combination thereof. After receiving the offers 120 from the offer application 110, person P can redeem one or more of the promotional offers or refer the offers 130 to fans F₁-F_{N} of person P.

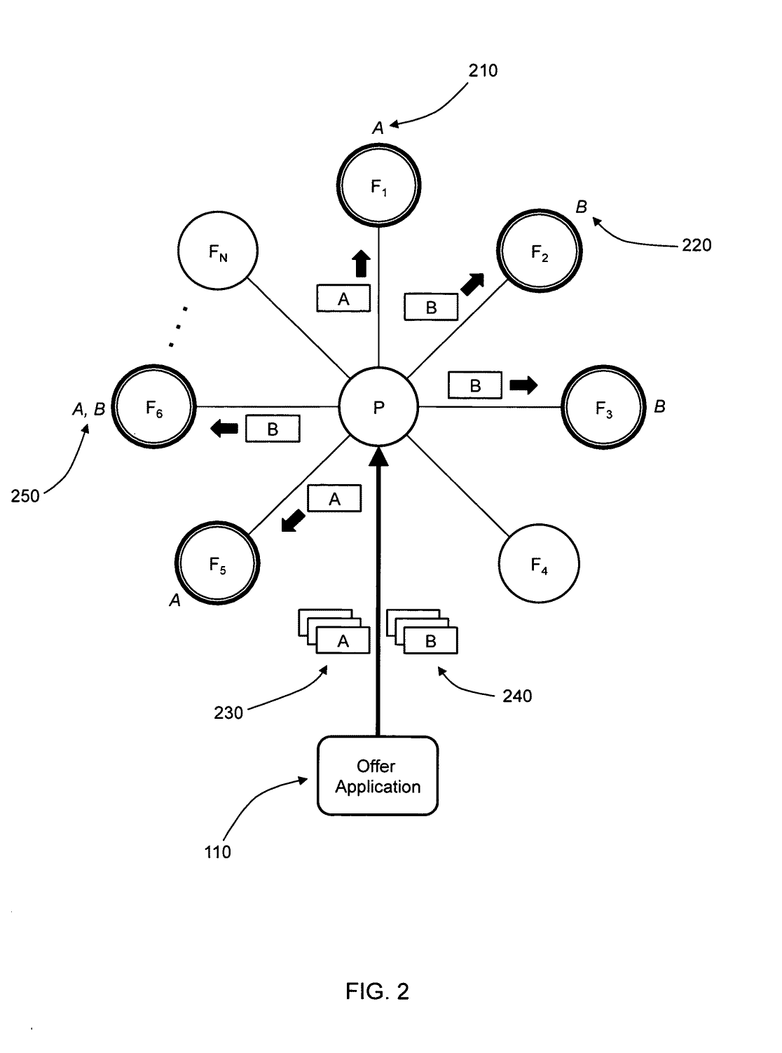

FIG. 2 shows a detailed embodiment of the invention, in which some of the fans F₁-F_{N} of person P have been characterized and offers 230, 240 are pushed to person P based on the characterization of the fans F₁-F_{N}. In particular, the fans F₁-F_{N} of person P are characterized with respect to one or more domains. For example, fans F₁ and F₅ are characterized as being associated with domain A, whereas fans F₂ and F₃ are characterized as being associated with domain B. A fan can also be characterized as being associated with multiple domains, e.g. fan F₆ is characterized as being associated with domains A and B. The domains can include any category that may be relevant for marketing purposes, including demographic categories, socio-economic categories, and interests, such as fashion, sports, entertainment, science, home, garden, camping, education, college, baby, philanthropic causes, charities, and virtually every type of common consumer goods.

A measure of influence of person P with respect to one or more domains can be determined at least partially based on the characterization of fans F₁-F_{N} of person P with respect to the same domains. The measure of influence of a person is used to determine which offers or domain of offers to push to the person. In FIG. 2, since person P has fans characterized as being associated with domains A and B, person P has a high measure of influence for those domains. Therefore, promotional offers 230 and 240 related to domains A and B, respectively, will be offered for endorsement to person P. The promotional offers 230 and 240 can then be shared with the fans F₁-F_{N} of person P.

It is important to note that promotional endorsement opportunities associated with a specific domain can be offered to person P, even if person P has no stated interest in that domain. In other words, person P can have a high measure of influence for promoting offers in a domain due to the characterizations of the fans F₁-F_{N} of person P and irrespective of the interests of person P himself or herself. For example, a person having multiple fans who are characterized as being interested in golf will have a high measure of influence for a golf domain. The offer application 110 will preferentially make available promotional opportunities related to golf to the person even if the person himself has no personal interest in golf.

The fans F₁-F_{N} of person P are characterized based on one or more monitored actions of the fans F₁-F_{N}. Monitored actions of a fan include, but are not limited to, an acceptance of promotional offers, a referral of promotional offers, a redemption of promotional offers, a frequency of receiving promotional offers, a frequency of referring promotional offers, a stated interest of promotional offers, a stated interest, or any combination thereof.

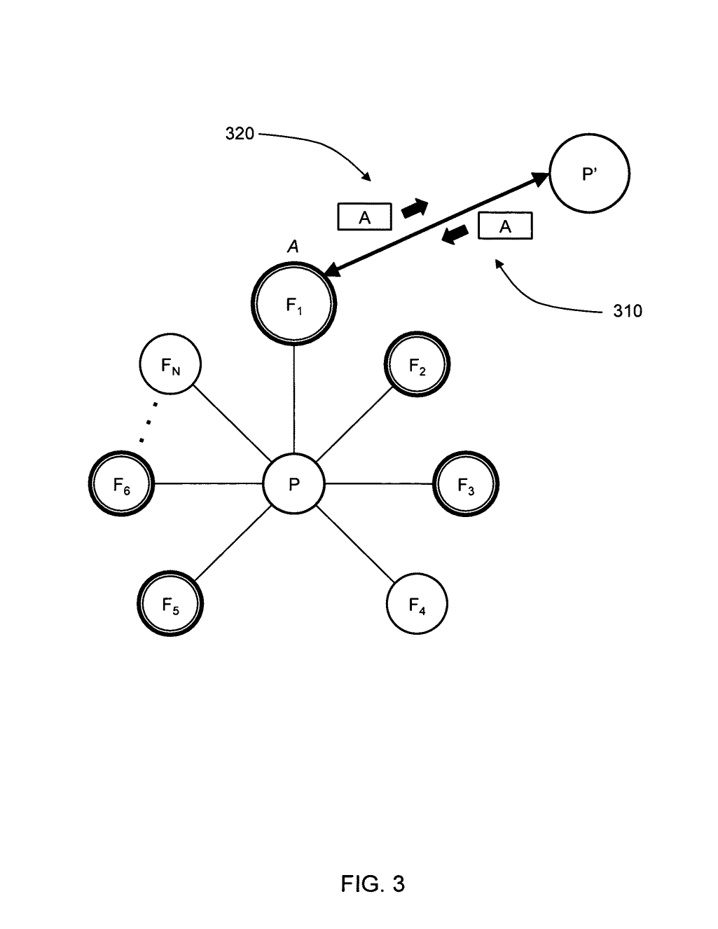

For example, FIG. 3 shows actions of fan F₁ of person P being monitored to characterize fan F₁ as being associated with domain A. The actions can include receiving a promotional offer 310 from another person P′ or referring a promotional offer 320 to person P′. The received or referred promotional offers are associated with domain A, therefore fan F₁ is characterized as having an interest in domain A. This characterization of fan F₁ affects the measure of influence of person P with respect to domain A. It is noted that the relationship between a person and a fan of the person could be bidirectional, in that a person could refer offers to the fan and receive offers referred by the fan, similar to the relationship between person P′ and fan F₁. Records of the monitored actions of the fans can be maintained, such as in a database. In an embodiment, the monitored record includes an identifier of each of said monitored fans.

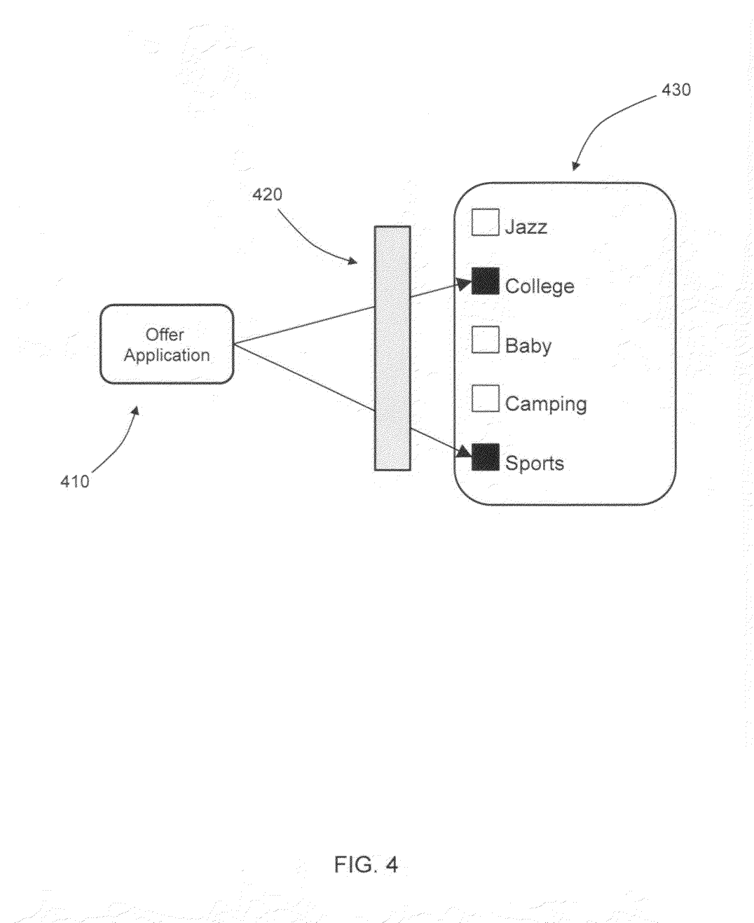

By monitoring the actions of fans of a person and characterizing the fans with respect to a domain, the community of fans of a person acts as a filter for the endorsement or testimonial opportunities for the person. FIG. 4 shows how a community of fans 420 of person 430 acts as a filter between the offer application 410 and person 430. In the example shown in FIG. 4, the community of fans 420 filters out the less relevant domains and enables the offer application to direct promotional opportunities only in the relevant domains of college and sports.

In an embodiment, the behavior or actions of a person can also be tracked. The tracked behavior of the person, along with the characterization of the fans of the person, can be used to determine the measure of influence of the person. The actions of the person to be tracked can be similar to the monitored actions of the fans, such as the referral of offers from the person to the fans of the person.

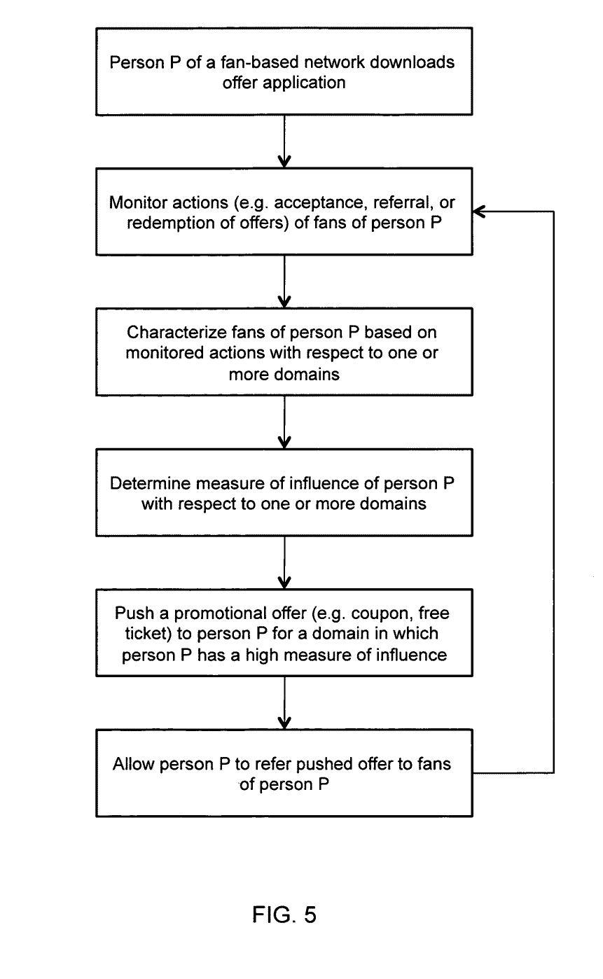

FIG. 5 shows a flowchart of an example method of pushing promotional offers based on a measure of influence. It is important to note that the measure of influence of a person is updatable. In an embodiment, the measure of influence of a person can be changed due to changes to the characterization of one or more fans, characterization of additional fans, actions done by the person, or additional monitored actions by one or more fans. Updating the measure of influence of a person with respect to domains allows for more effective selection of promotional offers to be pushed to the person.

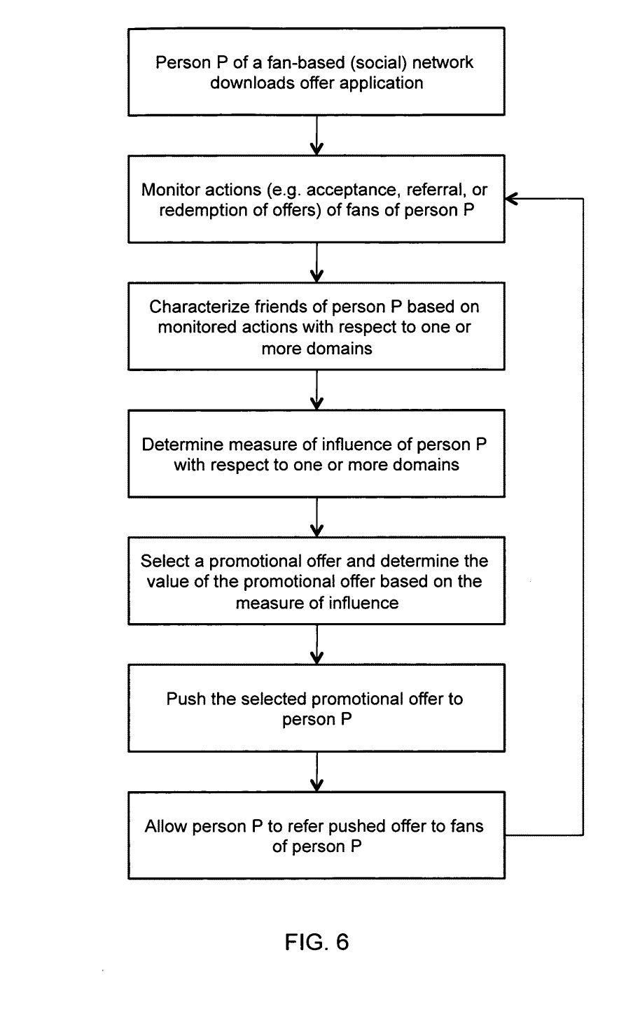

FIG. 6 shows a flowchart similar to the flowchart of FIG. 5. In the embodiment shown in FIG. 6, the value of the promotional offer is dependent on the measure of influence of the person. In a preferred embodiment, a promotional offer pushed to persons with high measures of influence has greater value than a similar promotional offer pushed to persons with low measures of influence. By having promotional offer values depend on the measure influence, persons can be rewarded for being influential.

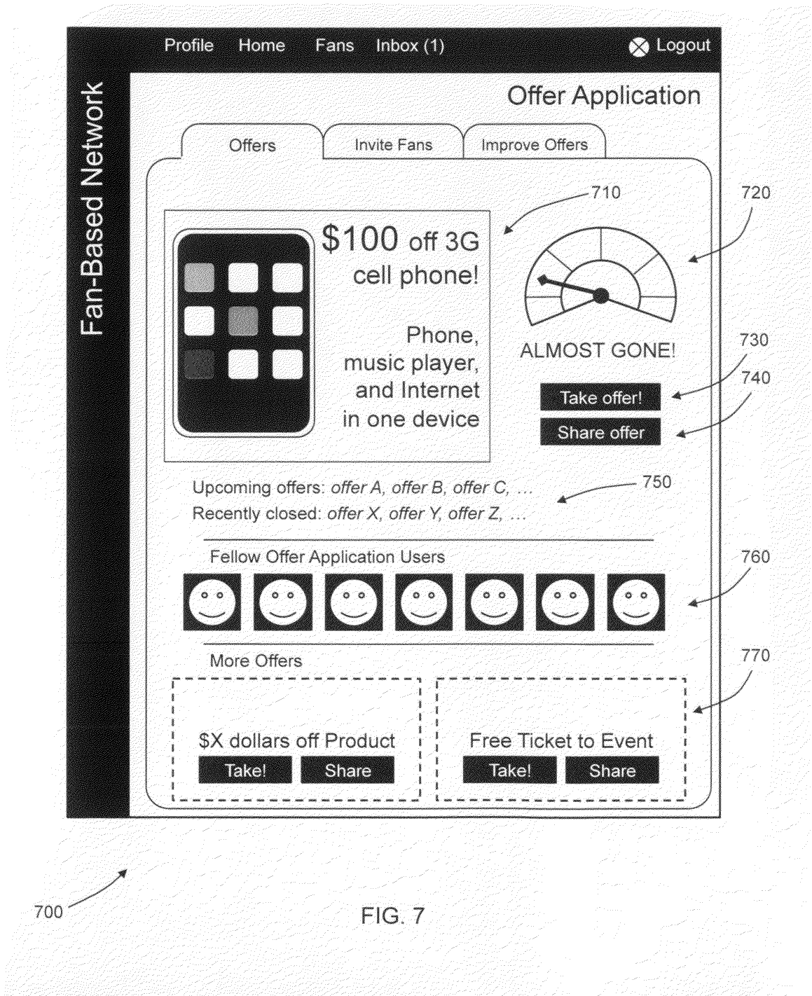

FIG. 7 shows an example graphical user interface (GUI) 700, such as a website, for the offer application. As can be appreciated by one of ordinary skill in the art, the offer application can be created for use in a platform provided by computer-implemented fan-based (social) networks. In an embodiment, the offer application GUI 700 is accessible by a person through a web browser, and preferably, after the person logs into a fan-based networking website. In an embodiment, the offer application must be downloaded by persons of a fan-based (social) network to receiving offers directly from the application.

The offer application GUI 700 includes an offer 710 pushed to a person of the fan-based network. In an embodiment, the availability 720 of the offer 710 is displayed. Preferably, offers having high value have more limited availability than low value offers. A person can take the offer 730 or share the offer 740 with other persons and/or to fans of the person. In the embodiment shown in FIG. 7, upcoming and past offers 750 are also displayed. In addition, the GUI 700 shows other persons 760 who are also users of the offer application. Any number of offers can be displayed by the offer application, including offers 770.

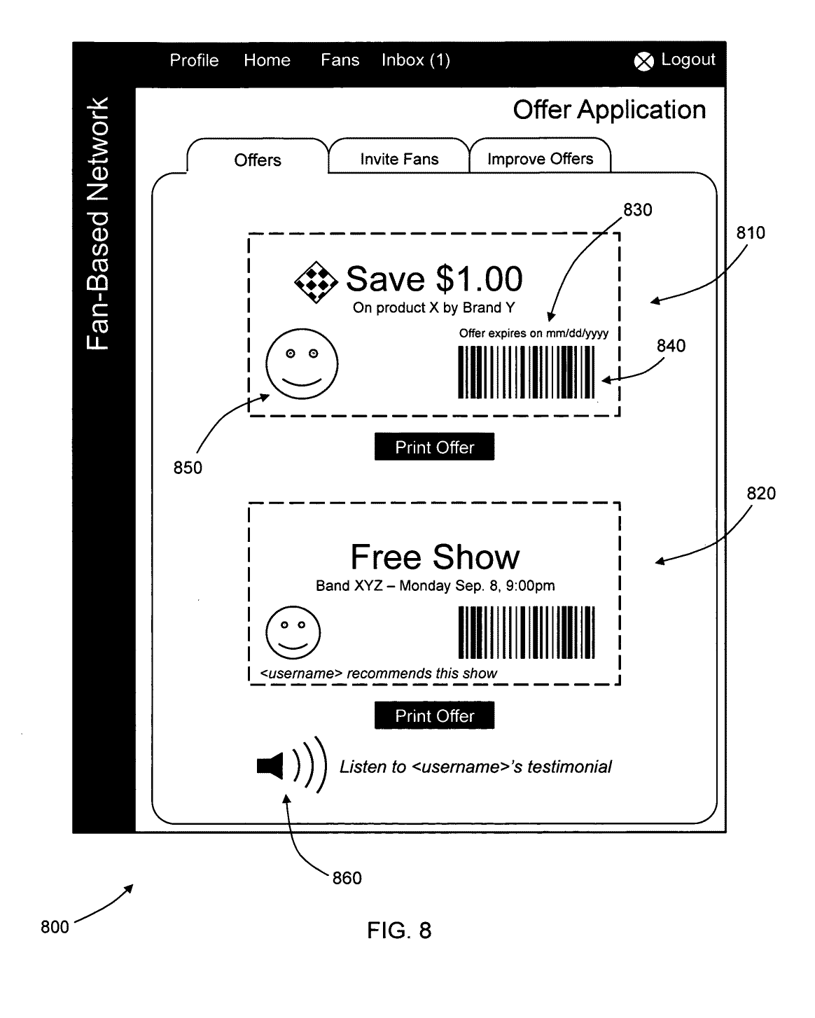

By taking or accepting an offer, a person is allowed to print or otherwise redeem the offer for the product or service indicated by the offer. An example first offer 810 to be printed is shown in FIG. 8. The first offer 810 is a discount coupon for product. The coupon can be redeemed at a retail store, an online retailer, or any other location that accepts the coupon. The first offer 810 can also include an expiration date 830 and a bar code 840. The bar code 840 enables redemption data to be tracked. In an embodiment, the bar code 840 includes personalized information related to the person receiving the first offer. FIG. 8 also shows an example second offer 820 for a free admissions ticket to a musical event.

In an embodiment, a pushed promotional offer includes an identifier or testimonial by another person of the fan-based network. For example, first offer 810 includes a picture 850 of a fan of the person receiving the offer. Other identifiers, including name or usernames can be incorporated on the offers. In another embodiment, the identifier includes a media, audio, or audio-visual clip 860 of another person of the fan-based network. The media clip can include a testimonial relating to the product, service, or event displayed on the offer 820. By having an identifier of a fan or another person of the fan-based network, offer referrals are more likely to be trusted by the receiving person.

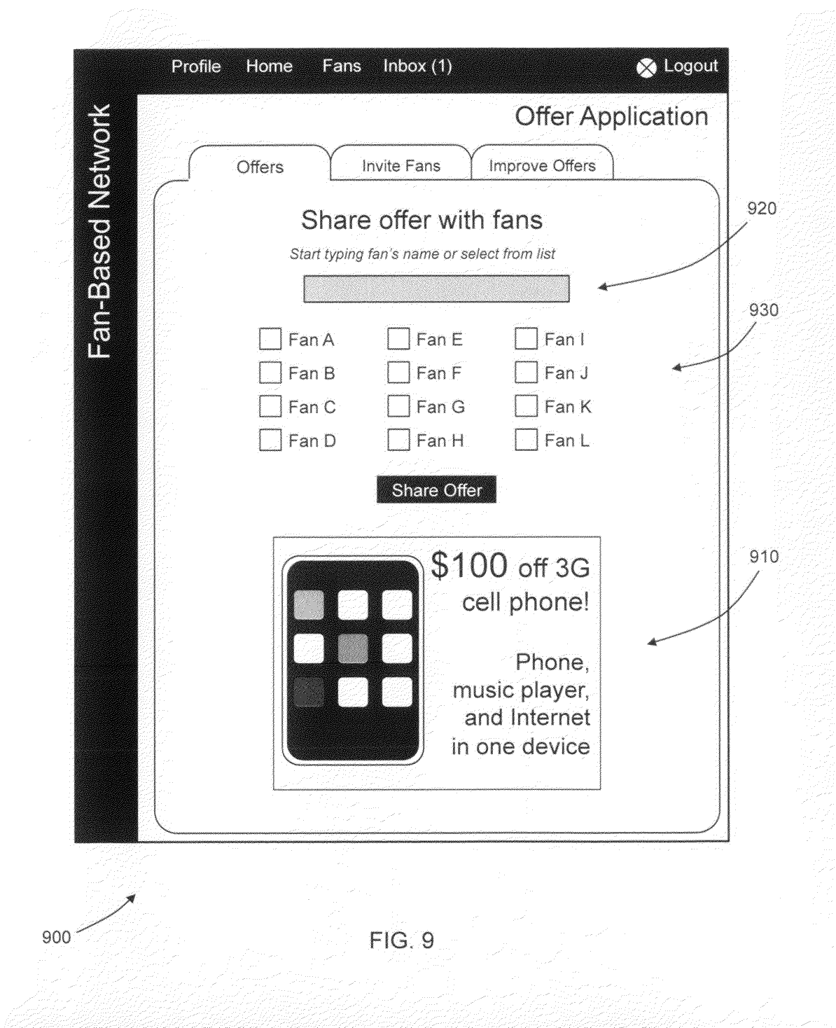

In a preferred embodiment, a person of a fan-based network who has received one or more promotional offers can share the offers to fans of the person. FIG. 9 shows a website GUI 900 for sharing or referring an offer 910 to fans. Referred fans can be entered 920 or selected from a list 930. By allowing offers to be shared, the promotional offers can spread rapidly and virally, particularly in a fan-based network setting. In an embodiment, the value of the offer 910 can be changed based on the number of referrals made by the person. For example, an offer of $10 off of a product can be increased to $50 off if a person refers the offer to 10 of his or her fans. In an embodiment, the condition for increasing the value of the offer based on the number of referrals can be indicated to the person. Alternatively, the increase in value can be done automatically without alerting the person.

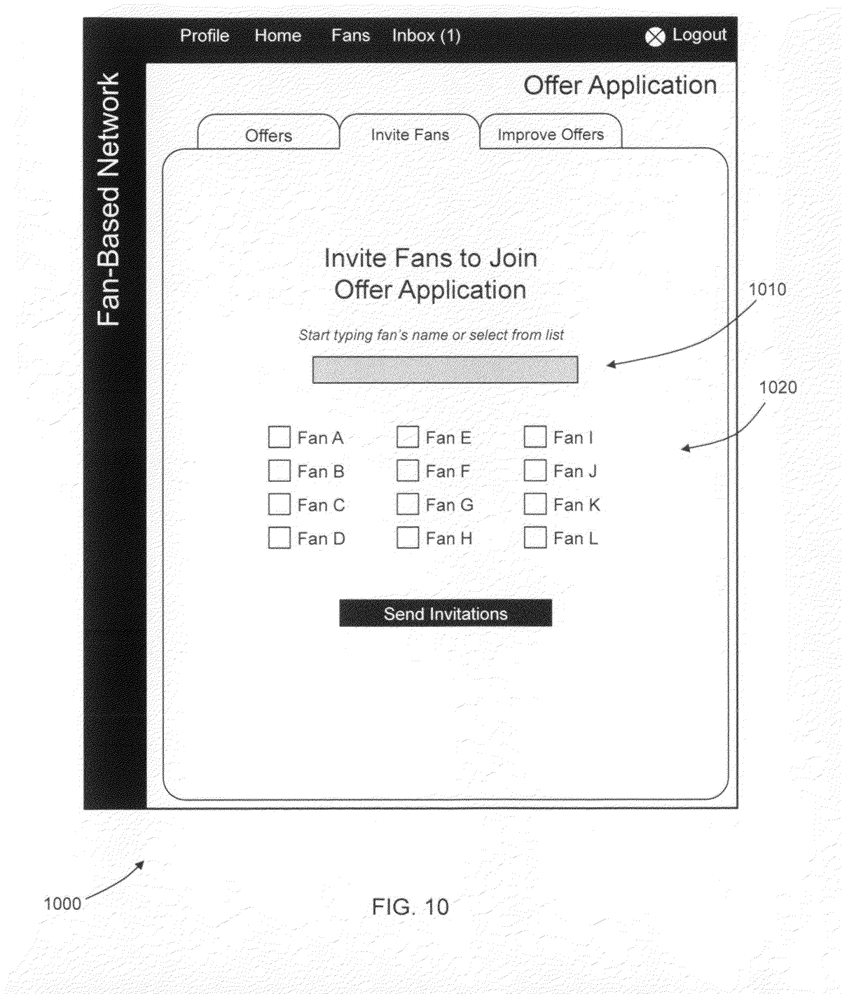

FIG. 10 shows a display 1000 of an invitation function for a person to invite his or her fans to join the offer application. The fans can be entered 1010 or selected from a list 1020. In an embodiment, the measure of influence of the inviting person and/or a value of a promotional offer can change based on a number of invitations. Similar to the offers themselves, the sharing or inviting to join the offer application enables a rapid and viral spread of the offer application.

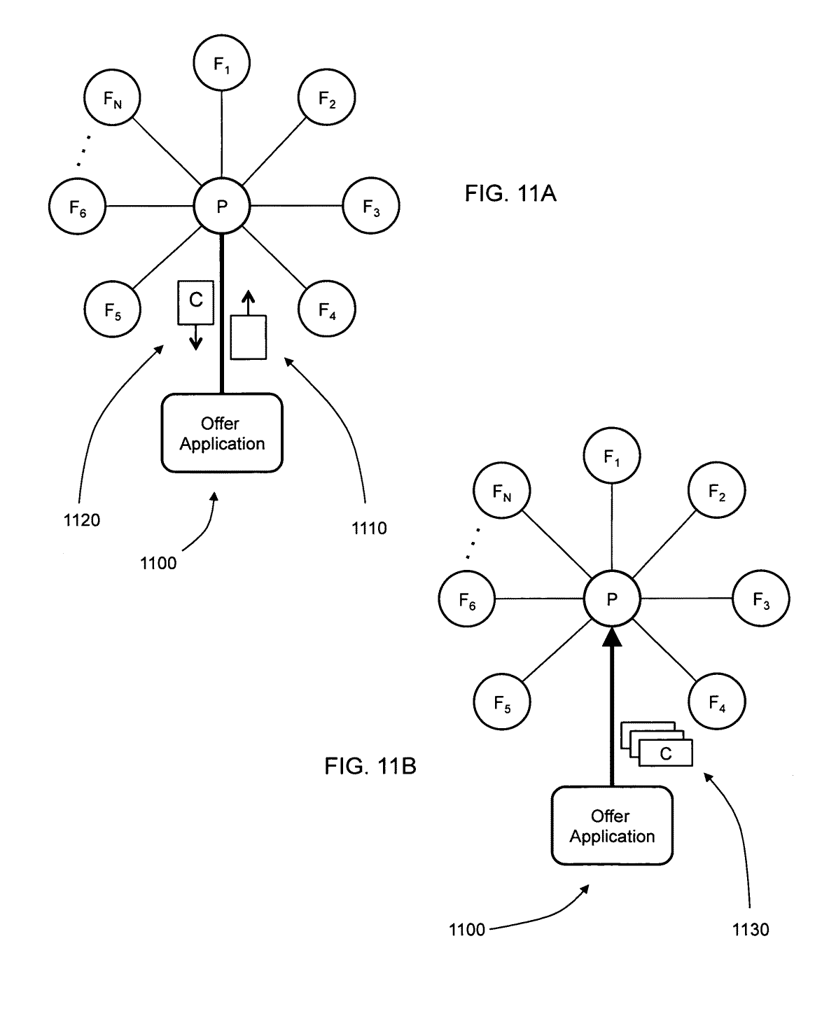

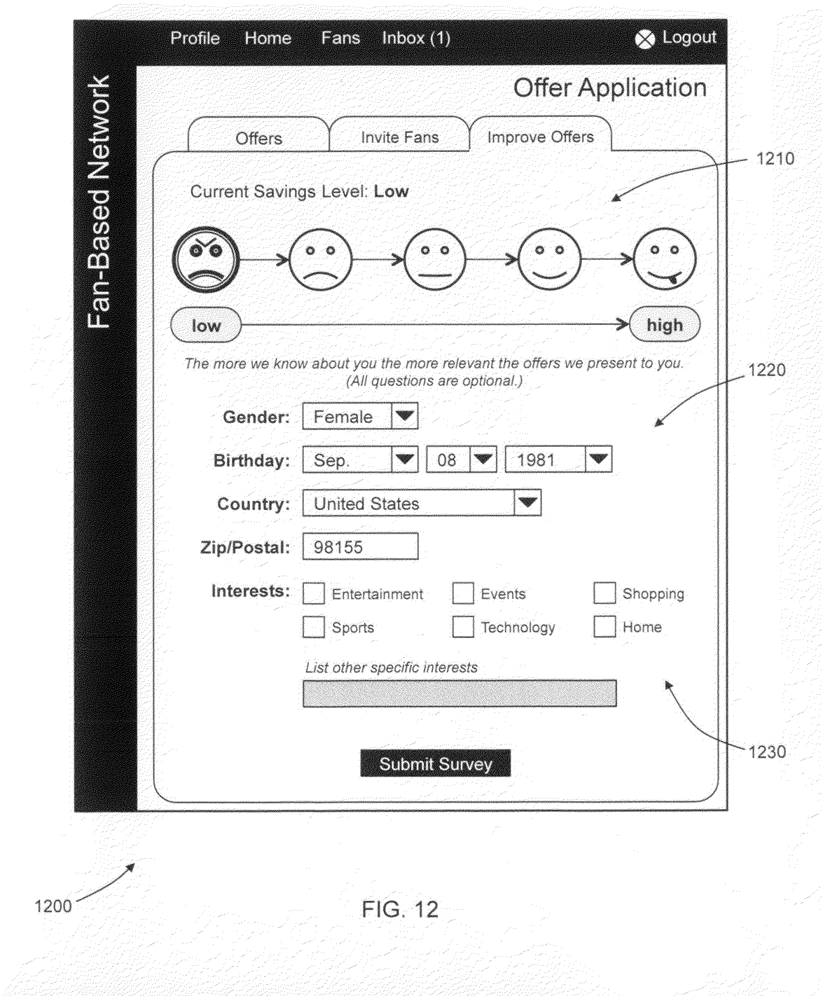

FIGS. 11-12 show embodiments of the present invention related to surveys transmitted to a person of the fan-based network. FIG. 11A shows a survey 1110 sent from the offer application 1100 to person M. The survey can be related to information about the person, interests of the person, interests of fans of the person, a usage pattern of the person, a usage pattern of one or more fans of the person, or any combination thereof. Person P completes and submits the survey 1120 to the offer application 1100. The completed survey 1120 can be used to determine a relevant domain to the person. For the example in FIG. 11A, the completed survey 1120 indicates that domain C is relevant to person P. One or more promotional offers associated with the relevant domain can be selected and pushed to the person. FIG. 11B shows promotional offers 1130 associated with domain C being pushed to person P.

Surveys can be used to increase the relevancy and the value of the pushed promotional offers. FIG. 12 shows an example of a survey 1200 for improving the value and relevancy of the offer. By completing the survey, a person can increase his or her savings level 1210, thereby the person can receive higher value offers. Surveys can include personal information, such as demographic information 1220 and/or information relating to interests 1230 of the person.

It is important to note that, as described above, a person's measure of influence and/or the values of promotional offers are updatable through actions of the person, actions of the fans of the person, or both. The actions that can lead to changes of the measure of influence and/or the value of promotional offers include, but are not limited to, referral of offers between two or more persons of a fan-based network, invitations to join or download the offer application, and submissions of completed surveys by persons of the fan-based network. It is also important to note that a person's measure of influence can change indirectly through actions of the person's community without the person having to act at all. By having updatable measures of influence, the relevancy of promotional offers pushed to the person can be improved. Furthermore, person usage and referral of pushed offers will, presumably improve with more relevant and higher value offers.

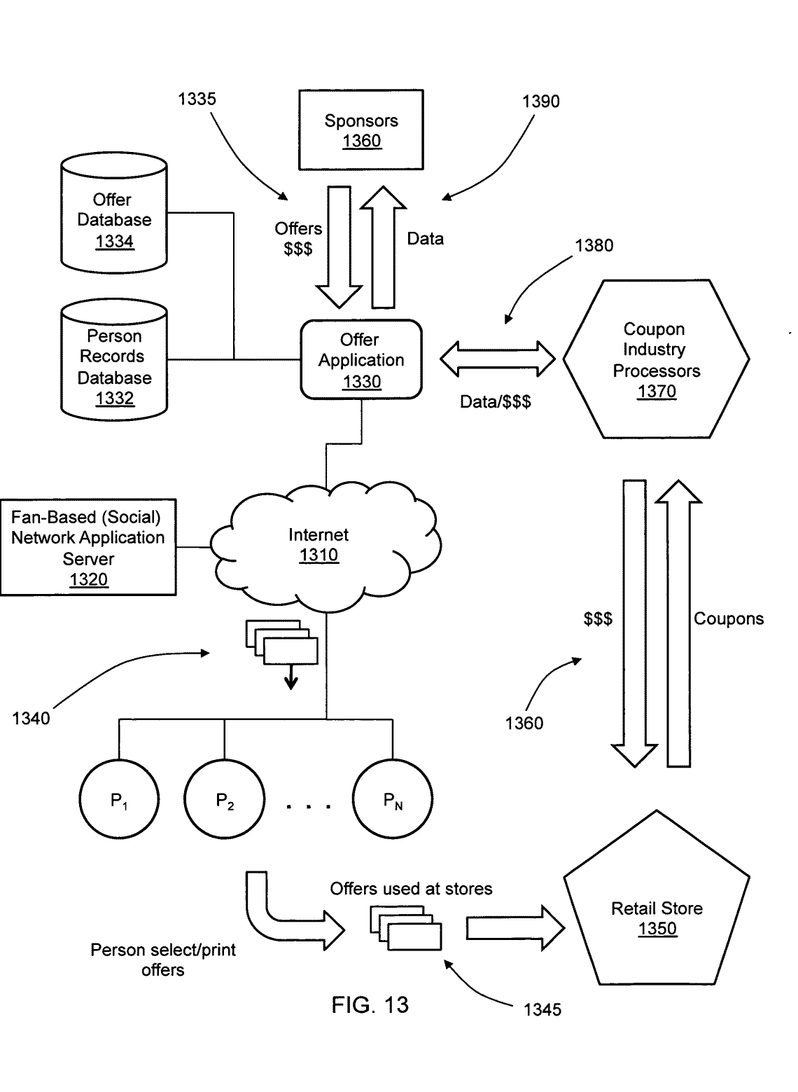

FIG. 13 shows an example offer distribution system including an offer application 1330 according to the invention. The offer application 1330 receives offers 1335 from sponsors 1360, such as companies, commercial enterprises, individuals, stores, manufacturers, universities, or any other entity wishing to distribute promotional offers. The offers can be stored in an offer database 1334.

The offer application 1330 can be accessed through a communication network, such as the Internet 1310. Preferably, persons P₁-P_{N} of a fan-based (social) network access the offer application through a fan-based network webpage operated by a fan-based (social) network application server 1320. The offer application 1330 distributes offers 1340 to the persons P₁-P_{N}, who can select and print the offers 1345. The printed offers can be used and redeemed at retail stores 1350. Alternatively or additionally, offers can include tickets or access passes for use at an event. In another embodiment, the offers 1340 are electronic offers to be used in an online environment instead of or in addition to a physical environment. Information relating to the selection or referral of offers is stored in a person records database 1332. FIG. 13 shows two separate databases for the offer database 1334 and the person records database 1332, however any number of databases can be used.

In the embodiment shown in FIG. 13, the redeemed offers or redemption information are transmitted to coupon industry processors 1370, such as redemption agents. Financial considerations are transferred 1360 between the coupon processors 1370 and the retail stores 1350. The redemption process between retail outlets 1350 and coupon processors 1370 is known in the art.

The redemption data and financial considerations 1380 are exchanged between coupon industry processors 1370 and the offer application 1330. The redemption data is used by the offer application 1330 to update person records in the offer person records database 1332. As described above, redemption data can be used to update persons' measures of influence and used by the offer application 1330 to improve the relevancy and value of the offers 1340 pushed to the persons P₁-P_{N}. In an embodiment, information relating to the persons, such as offer selection data, offer referral data, and redemption data, can be transmitted 1390 to the sponsors 1360 for marketing or other purposes of the sponsors 1360.

As one of ordinary skill in the art will appreciate, various changes, substitutions, and alterations could be made or otherwise implemented without departing from the principles of the present invention, e.g. the Internet can be replaced by any network, such as a WAN or LAN, and any type of offer for products, services, or events can be provided by the offer application. The invention can be implemented by having one or more digital storage media embodying machine readable instructions executable on one or more computers or computer/application servers. Accordingly, the scope of the invention should be determined by the following claims and their legal equivalents.

What is claimed is:

1. A method of pushing promotional offers to a person of a computer-implemented fan-based network based on behavior of fans of said person, said method comprising:
(a) monitoring one or more actions of multiple fans of said person of said computer-implemented fan-based network, wherein each of said fans of said person has a pre-existing relationship with said person by at least being a fan of said person;
(b) characterizing at least one of said fans of said person based on said one or more monitored actions of said fans, wherein said characterizing is with respect to one or more domains;
(c) determining a measure of influence of said person with respect to one or more of said domains, wherein said measure of influence is at least partially based on said characterizing of said fans of said person;
(d) having a plurality of promotional offers, wherein each of said promotional offers is associated with one or more of said domains; and
(e) pushing at least one of said promotional offers to said person based on said measure of influence of said person and said domain associated with said pushed promotional offer.

2. The method as set forth in claim 1, wherein said person is an artist, a celebrity, an athlete, a politician or any person with a fan-base of people.

3. The method as set forth in claim 1, wherein said monitored actions of said fans of said person comprises an acceptance of promotional offers, a referral of promotional offers, a redemption of promotional offers, a frequency of receiving promotional offers, a frequency of referring promotional offers, a stated interest of promotional offers, a stated interest, or any combination thereof.

4. The method as set forth in claim 1, further comprising determining a value of said promotional offer pushed to said person, wherein said value determining is based at least partially on said measure of influence of said person.

5. The method as set forth in claim 1, further comprising providing a refer function for allowing said person to refer said pushed promotional offer to said fans of said person.

6. The method as set forth in claim 5, further comprising determining a value of said promotional offer pushed to said person, wherein said value determining is based at least partially on a number of said referrals by said person.

7. The method as set forth in claim 1, further comprising maintaining a record of said fans of said person, wherein said record comprises an identifier for each of said fans and said monitored actions of each of said fans.

8. The method as set forth in claim 1, further comprising providing a survey to said person, wherein said survey is related to an interest of said person, an interest of said fans of said person, a usage pattern of said person, a usage pattern of one or more of said fans of said person, or any combination thereof.

9. The method as set forth in claim 8, further comprising:
(a) determining a relevant domain for said person based on said survey;
(b) selecting a second promotional offer to push to said person of said fan-based network, wherein said selecting said second promotional offer is based on said relevant domain of said person; and
(c) pushing said second promotional offer to said person.

10. The method as set forth in claim 1, wherein said promotional offer pushed to said person includes an identifier associated with one of said fans of said person, and wherein said identifier comprises text, an audio clip, a visual graphic, an audio-visual clip, or any combination thereof.

11. The method as set forth in claim 1, wherein said promotional offers are directed to a product or a service of one or more sponsors, and wherein said plurality of promotional offers comprises a discount, a coupon, an advertisement, a voucher, an incentive to purchase, a ticket, an access pass, or any combination thereof.

12. The method as set forth in claim 1, further comprising tracking behavior of one of said persons of said fan-based network, wherein said measure of influence of the same of said persons is at least partially based on said tracked behavior of the same of said persons.

13. The method as set forth in claim 1, wherein said relationship between said person and each of said fans of said person is bidirectional, wherein said person can refer said promotional offers to said fans of said person, and wherein said person can receive said promotional offers referred by at least one of said fans of said person.

14. A system for measuring influence and pushing promotional offers, said system comprising:
(a) a computer-implemented fan-based network of a plurality of persons, wherein each of said persons of said fan-based network has one or more fans;
(b) a monitor function for monitoring actions of said fans of one or more of said persons;
(c) a characterize function for characterizing at least one of said fans of one or more of said persons based on said one or more monitored actions of said fans, wherein said characterizing is with respect to one or more domains;
(d) an influence function for determining a measure of influence of each of said persons with said monitored fans, wherein said measure of influence is with respect to one or more of said domains, and wherein said measure of influence is at least partially based on said characterizing of said fans of the same of said persons;
(e) a plurality of promotional offers, wherein each of said promotional offers is associated with one or more of said domains; and
(f) an offer function for pushing at least one of said promotional offers to be received by at least one of said persons, wherein said pushed promotional offers are based on said measure of influence of each of said receiving persons and said domains associated with said pushed promotional offers.

15. The system as set forth in claim 14, wherein said person is an artist, a celebrity, an athlete, a politician or any person with a fan-base of people.

16. The system as set forth in claim 14, wherein said monitored actions of said fans of said person comprises an acceptance of promotional offers, a referral of promotional offers, a redemption of promotional offers, a frequency of receiving promotional offers, a frequency of referring promotional offers, a stated interest of promotional offers, a stated interest, or any combination thereof.

17. The system as set forth in claim 14, wherein a value of one of said promotional offers pushed to one of said persons is based at least partially on said measure of influence of the same of said persons.

18. The system as set forth in claim 14, further comprising a refer function for allowing one of said persons to refer at least one of said pushed promotional offers to said fans of the same of said persons.

19. The system as set forth in claim 14, further comprising a database for storing a record of said fans of each of said persons, wherein said record comprises an identifier for each of said fans of the same of said persons and said monitored actions of each of said fans of the same of said persons.

20. The system as set forth in claim 14, further comprising a survey function for providing one or more surveys to some of said persons of said computer-implemented fan-based network, wherein said surveys are related to an interest of said person, an interest of said fans of said person, a usage pattern of said surveyed persons, a usage pattern of one or more of said fans of said surveyed persons, or any combination thereof.

21. The system as set forth in claim 20, wherein said offer function:
determines a relevant domain for said person based on said survey;
selects a second promotional offer to push to said person of said fan-based network, wherein said selecting said second promotional offer is based on said relevant domain of said person; and
pushes said second promotional offer to said person.

22. The system as set forth in claim 14, wherein one of said promotional offers pushed to one of said persons includes an identifier associated with one of said fans of the same of said persons, and wherein said identifier comprises text, an audio clip, a visual graphic, an audio-visual clip, or any combination thereof.
